(19) United States
(12) Patent Application Publication
(10) Pub. No.: US 2008/0132303 A1
(43) Pub. Date: Jun. 5, 2008

(54) Extendible mobile device

(76) Inventors: Samu Naukkarinen, Espoo (FI); Annika Hirvonen, Espoo (FI)

Correspondence Address: Hollingsworth & Funk, LLC, Suite 125, 8009 34th Avenue South, Minneapolis, MN, 55425, US

(21) Appl. No.: 11/633,182

(22) Filed: Dec. 4, 2006

(51) Int. Cl. H04M 1/00

(52) U.S. Cl. 455/575.4

(57) ABSTRACT

The present invention relates to the field of mobile devices. In particularly, the present invention relates to the field of in general extendible devices, and is especially applicable to slidable devices and/or mobile/portable (electronic) devices. The extendible mobile electronic device, comprises a device housing having at least a first housing element, which comprises a first front surface and a first rear surface, a second housing element, which comprises a second front surface and a second rear surface and one or more level slide mechanisms. Each of which level slide mechanisms comprises a linking element having a sliding rail and a pair of first sliding elements, a guideway element located at the second housing element, being in slidable engagement with said sliding rail and a pair of second sliding elements located at the first housing element, being in slidable engagement with said first sliding elements. Said first housing element and said second housing element are extensibly supported by said level slide mechanisms to each other, such that said first and second housing elements can adopt a retracted configuration and an extended configuration with respect to each other.

### FIELD OF THE INVENTION

The present invention relates to the field of mobile devices. In particularly, the present invention relates to the field of extendible devices in general, and is especially applicable to slidable devices and/or mobile/portable (electronic) devices.

### BACKGROUND

Slidable mobile or portable electronic devices such as consumer electronic devices, mobile telephones, palmtops, and communicators are well known in the art and are available from a huge number of different manufacturers.

Especially, in the technical field of cellular telephones three main types of extendible devices are available, the flip cellular telephones, clamshell cellular telephones, or slidable cellular telephones such as the Nokia's Models N71 and N80. Sliding phones like the Nokia's Model N80 have typically a large display and an ITU-T keypad that becomes accessible when the front part of the two-piece housing is displaced upwards (forwards). Further form factors and extension mechanisms are also known in the technical field of cellular telephones. Exemplarily, rotatable/pivotable mechanisms such as implemented with Nokia's Model 7370 and mechanisms combining one or more of the above mentioned mechanisms e.g. Nokia's Model N90 have been developed.

However, the known approaches and designs of slidable mobile devices typically having a two-piece housing suffer from a common disadvantage in view of usability. The keypads and the display are arranged in different and typically substantially parallel planes due to their arrangement with different parts of the two-piece housing. Conventionally, keys destined for navigation through the user interface such as a multi-directional switch or joystick and/or keys for initiating/answering and/or ending a call are arranged with the part of the housing which comprises the display, whereas the more space requiring ITU-T keypad is arranged with the other part of the housing. For instance, during inputting a telephone number and initiating the call set-up, a user has to actuate one or more keys of the ITU-T keypad as well as one or more keys arranged at the housing part comprising the display. Due to the thickness of the housing part comprising the display, the user may find the different levels at which the keys are arranged irritating or annoying.

The problem of conventional concepts resides in that they require a complex motion and therefore use complex mechanical mechanisms. The display housing element has to slide half of the length of the whole phone, which creates limits for the dimensions of mechanism. Because of the long motion path, mechanism also becomes easily unstable and looses its stiffness. Another big problem of conventional concepts reside in that the direction of motion changes when display housing element falls to the same level as the keyboard housing element to achieve flushing surfaces. This is the most critical phase of the motion and with the long distance of support faces, the movement is very hard to handle. Furthermore, at this point the housing elements are hardly in physical touch.

It is also desirable to provide simple and reliable sliding mechanism to improve the operability of slidable mobile devices and to enhance the usability of such slidable mobile devices.

It is similarly desirable to provide a mobile device provided with a simple and reliable sliding mechanism.

It is also desirable to have a simple mechanical solution for complicated mechanical movement that allows implementing a slide or “level slide” mechanism.

### SUMMARY OF THE INVENTION

According to an aspect of the present invention, an extendible mobile or portable electronic device, in particular an extendible portable electronic device, is provided. The portable electronic device comprises inter alia a device housing, which has at least a first housing element with a first front surface and a first rear surface and a second housing element with a second front surface and a second rear surface, and one or more slide mechanisms.

The one or more slide mechanisms each comprise a linking element, a guideway element and second sliding elements located at the first housing element. Each of the linking elements has a sliding rail and a pair of first sliding elements. Each of the guideway elements is located at the second housing element of the electronic device, being in slidable engagement with a respective one of the sliding rails. Each of said pairs of second sliding elements is located at the first housing element, being in slidable engagement with a respective one of said first sliding elements.

Said first housing element and said second housing element are extensibly supported by said slide mechanisms, such that said first and second housing elements can adopt a retracted configuration and an extended configuration with respect to each other.

According to an embodiment of the present invention, a conversion of the device housing from the retracted configuration to the extended configuration permits a first movement of the housing elements substantially in parallel to each other and a second movement of the housing elements approaching each other

In said retracted position said first housing element and said second housing element are located substantially on top of each other, said first rear surface is conformingly adjoining said second front surface. In said extended position said first housing element is displaced with respect to said second housing element and a section of said second front surface is adjoining said and flushing with said first front surface.

That is, in said retracted position the second front and said first rear surfaces are substantially or at least partially covered by each other. That is, the second front and said first rear surfaces are substantially or at least partially uncovered by each other in said extended position. To achieve the target that the second front surface is adjoining said and flushing with said first front surface it is necessary to provide at least a two dimensional movement of the second housing element with respect to the first housing element. Two successively performed straight sliding motions may achieve the movement. The first linear sliding motion can extend the device in the conventional slidephone manner and a subsequent straight sliding/shifting motion can move the second front surface into a position adjoining said and flushing with said first front surface. However, the design of mobile telephones is not restricted to flat front configurations. In case of a flat first front side, and a flat second front side, said section of said second front surface is adjoining said first front surface and said section of said second front surface is arranged in (substantially) the same plane as said first front surface. However, the present invention is also applicable to e.g. curved front surfaces or curved configurations of mobile phones.

In just another example embodiment said first sliding elements and said second sliding elements allow a first movement of said housing elements substantially in parallel to each other and a second movement of said housing elements approaching each other.

That is, the first sliding elements and said second sliding elements participate as well in the sliding movement and in the shifting movement, whereas the sliding rail and the guideway element only participate in the sliding movement.

That is, in this embodiment the linking element performs a sliding movement with respect to both housing elements. Similarly, the linking element performs a shifting movement only with respect to one of said housing elements.

That is, the housing elements may be stabilized with respect to conventional embodiments in that relative sliding motion of the housing elements with respect to each other is divided in two movements each with half the stroke, of each housing element with respect to the linking element. This new configuration allows a considerable improvement with respect to solutions using a single sliding rail for the full stroke/for the full length of the movement of the housing elements.

In an example embodiment of the present invention at least one of said first sliding elements is formed by a guiding grooves and at least one of said second sliding elements is formed by a pin. The pin may be provided with a liner to improve the sliding movement.

In another example embodiment of the present invention at least one of said second sliding elements is formed by a guiding grooves and at least one of said first sliding elements is formed by a pin. The pin may be provided with a liner to improve the sliding movement.

In an example embodiment, each said at least one guiding groove is curved. The curved configuration of the guiding grooves enable to combine the extending sliding movement and the shifting leveling movement to be performed in a single motion. This is achieved by deflecting the sliding movement by the curved (bent) guiding grooves to the leveling movement to the shifting leveling movement.

It may be noted, that the pin may be supported rotatably. The pin can be provided with a rotatable sleeve to reduce the friction of the shifting movement.

It may be emphasized, that the groves may be have a sharp bend or may be curved to enable the first and second sliding elements to participate in said sliding movement as well as in said shifting movement. It may be emphasized, that the groves may also be provided with a curved configuration so that the first and second housing elements are separated by lifting the first housing element. It may also be emphasized, that the groves may also be provided with a curved configuration so that the first and second housing elements are slightly tilted before reaching the retracted/extended position.

According to an embodiment of the present invention, the sliding rail(s) and the guideway element(s) are enabled for sliding in guidance by the guideway element(s) such that the housing elements is enabled for moving against each other in a direction of extension.

In another example embodiment said pair of first sliding elements and said pair of second sliding elements (located at the first housing element and, being in slidable engagement with said first sliding elements) are enabled for sliding said first housing element in relation to said second housing element to approach each other by a shifting movement, while in particular substantially maintaining orientations of said housing elements in relation to each other.

According to an embodiment of the present invention, the pair of first sliding elements and, said pair of second sliding elements (located at the first housing element, being in slidable engagement with said first sliding elements) are enabled for shifting or sliding said first housing element in relation to said second housing element to approach each other, or being moved towards each other, by the shifting movement. In particular, orientations of the housing elements are substantially maintained in relation to each other during the shifting movement.

In an example embodiment the direction of extension and a direction of said shifting movement are arranged at an angle between 20° and 70°. In another example embodiment the direction of extension and a direction of said shifting movement are arranged at an angle between 25° and 65°. In yet another example embodiment the direction of extension and a direction of said shifting movement are arranged at an angle between 30° and 60°. In still another example embodiment the direction of extension and a direction of said shifting movement are arranged at an angle between 35° and 55°. In an example embodiment the direction of extension and a direction of said shifting movement are arranged at an angle between 40° and 50°. In an example embodiment the direction of extension and a direction of said shifting movement are arranged at an angle between 60° and 70°. The different acute angles (>45°) have the advantage that the transition between the sliding and the shifting movement may be embodied in a more smooth way. The different more obtuse angles (<45°) have the advantage that the housing may be designed in a more rectangular design. It may be noted that the sliding movement and the shifting movement may be embodied in a way the shifting movement comprises a component reverse to the sliding movement. It is expected that angels smaller than 45° may lead to housings having a basically rhombic shape. We also expect that angles grater than 45° may lead to difficulties in continuing the movement in the area of the sharp bend.

According to an embodiment of the present invention, an orientation of the guideway elements and said sliding rails define a direction of extension of the extendible device housing. This means that the orientation of the guideway elements corresponds substantially to the direction of extension. The guideway elements are correspondingly oriented in accordance with the extension direction of the extendible device housing.

According to an embodiment of the present invention, one of the slide mechanisms is arranged at a side of the device housing and another one of the slide mechanisms is arranged at an opposite side of the device housing. The side and opposite side of the device housing should be defined in relation to a direction of extension. The slide mechanisms may be arranged internally and/or externally with the device housing.

According to an embodiment of the present invention, in the retracted configuration, the first housing element and the second housing element are located substantially on top of each other. In the retracted position the first rear surface conformingly adjoins the second front surface.

According to an embodiment of the present invention, in the extended configuration, the first housing element is displaced with respect to the second housing element. At least a section of the second front surface should adjoin at least a section of the second front surface, i.e. the first rear surface should partially adjoin the second front surface. In particular, the first rear surface conformingly adjoins the second front surface.

According to an embodiment of the present invention, in the extended configuration, the first front surface flush with the second front face. This means that the exposed front surfaces of the first and second housing elements should be displaced in a common plane in space and the term “exposure” should be understood herein as exposed to exterior of the device. Moreover, the first and second housing elements are arranged at the same level, substantially.

According to an embodiment of the present invention said device comprises a combined linking element having two sliding rails and two a pair of first sliding elements, combined in a single element. The two guideway elements located at opposite sides of said second housing element, each being in slidable engagement with one of said two sliding rails. The two pairs of second sliding elements located at opposite sides of the first housing element, being in slidable engagement with said first sliding elements.

This embodiment allows a smoother extending movement ensuring that said sliding motion and said shifting motion of the housing element is performed simultaneously.

According to an embodiment of the present invention, the first rear and the second front surfaces have a stepped configuration.

According to an embodiment of the present invention, the device further comprises a display, which is arranged on the first front surface, a user input interface element, which is arranged on the section of the second front surface, and processing means, which is connected to the display and to user input interface element.

According to an embodiment of the present invention, the device further comprises one or more applications operable with said device; and a sensor for detecting said configuration of said device housing. The one or more applications are reactive to a signal supplied by said sensor. The signal is indicative of the housing configuration.

According to an embodiment of the present invention, the device further comprises a pawl for locking the housing in the retracted and/or in the extended configuration.

According to an embodiment of the present invention, the device further comprises a cellular telephone module enabling for cellular communications.

According to just another embodiment of the present invention, the device further comprises at least one spring for biasing the first and second housing elements with respect to each other. The spring may urge the housing elements towards the retracted position. The spring may urge the first housing element towards the linking element for locking the housing elements in the extended position.

In another example embodiment of the present invention the device further comprises a first housing engagement element and a second housing engagement element. Said first housing engagement element is located at said first housing element. Said second housing engagement element is located at said second housing engagement element. Said first and second housing elements are configured to engage each other in at least one position of the device.

Said first and second housing elements may for example be configured to engage each other in the retracted position of the device. Said first and second housing elements may also be configured to engage each other in the extended position of the device. It is also envisaged to implement said first and second housing elements in a way that they are in engagement with respect to each other in both the retracted and in the extended position of the device. It is contemplated to design said first and second housing elements in a way that they are in engagement in both the retracted and in the extended position and during motions of both housing elements (with respect to each other).

It is noted, that the device may further comprise additional first and second housing engagement elements.

In an example embodiment, said first and second housing engagement element comprise a rail pin and a guide rail. In this embodiment, the rail pin engages the guide rail and guides the motion of both housing elements during the transition between the extended and the retracted positions. In this embodiment the shape of the guide rail represents a superposition (of a number of possible superpositions) of the motion paths of the sliding rail/guide way on one hand and the pairs of first and second sliding elements on the other hand.

In an example embodiment of the present invention, said first and second housing engagement elements comprise engagement portions to engage each other in the extended position. In another example embodiment of the present invention, said first and second housing engagement elements comprise engagement portions to engage each other in the retracted position.

According to another aspect of the present invention, a slide mechanism is provided. Said slide mechanism comprises a linking element, a first frame element and a second frame element. Said linking element has a sliding rail and a pair of first sliding elements. The first frame element is provided for being attached to one of said first and second housing elements. The first frame element comprises a guideway element, being in slidable engagement with said sliding rail of said linking element. Said second frame element is provided for being attached to the other one of said first and second housing elements. Said second frame element comprises a pair of second sliding elements, being in slidable engagement with said first sliding elements.

In an example embodiment said first sliding elements and said second sliding elements allow a first movement of said frame elements substantially in parallel to each other and a second shift movement of said frame elements approaching each other.

That is, the first sliding elements and said second sliding elements participate as well in the sliding movement and in the shifting movement, whereas the sliding rail and the guideway element only participate in the sliding movement.

That is, in this embodiment the linking element performs a sliding movement with respect to both frame elements. Similarly the linking element performs a shifting movement only with respect to one of said frame elements.

That is, the frame elements may be stabilized with respect to conventional embodiments in that relative sliding motion of the frame elements with respect to each other is divided in two movements each with half the stroke/half the length of the movement of the frame elements, allowing a considerable improvement with respect to solutions using a single sliding rail for the full length of the movement of the frame elements.

### BRIEF DESCRIPTION OF THE DRAWINGS

In the following, the invention will be described in detail by referring to the enclosed drawings in which:

FIG. 1 depicts a perspective view of a link element of a slide mechanism according to an embodiment of the present invention.

FIG. 2A shows a plan view of the link element of FIG. 1.

FIGS. 2B and 2C show a plan view of other embodiments of a link element.

FIG. 3A depicts plan views of a mobile phone embodiment of the present invention, with two housing elements depicted in a retracted configuration.

FIG. 3B shows plan views of the mobile phone embodiment of FIG. 3A depicted in an extended configuration.

FIG. 4 shows a perspective view of an extendable device to visualize the slide mechanism.

FIG. 5 shows schematic perspective side views of an extendable device to visualize the relative motion of the two housing elements.

FIGS. 6A, 6B and 6C show side views of three different embodiments of mobile electronic terminal devices in retracted and extended configurations.

FIG. 7 shows schematic perspective side views of an extendable device to visualize the relative motion of the two housing elements.

FIG. 8 shows a side view of an embodiment of a mobile electronic terminal device provided with housing engagement portions in retracted and extended configuration, respectively.

### DETAILED DESCRIPTION

In the detailed description, which follows, same or identical components have been given the same reference numerals, regardless of whether they are shown in different embodiments of the present invention. In order to clearly and concisely illustrate the present invention, the drawings may not necessarily be to scale and certain features may be shown in somewhat schematic form. Especially in embodiments in which both housing elements may be used as first or second housing elements both housing elements are provided with both reference signs.

FIG. 1 depicts a perspective view of a link element of a slide mechanism according to an embodiment of the present invention.

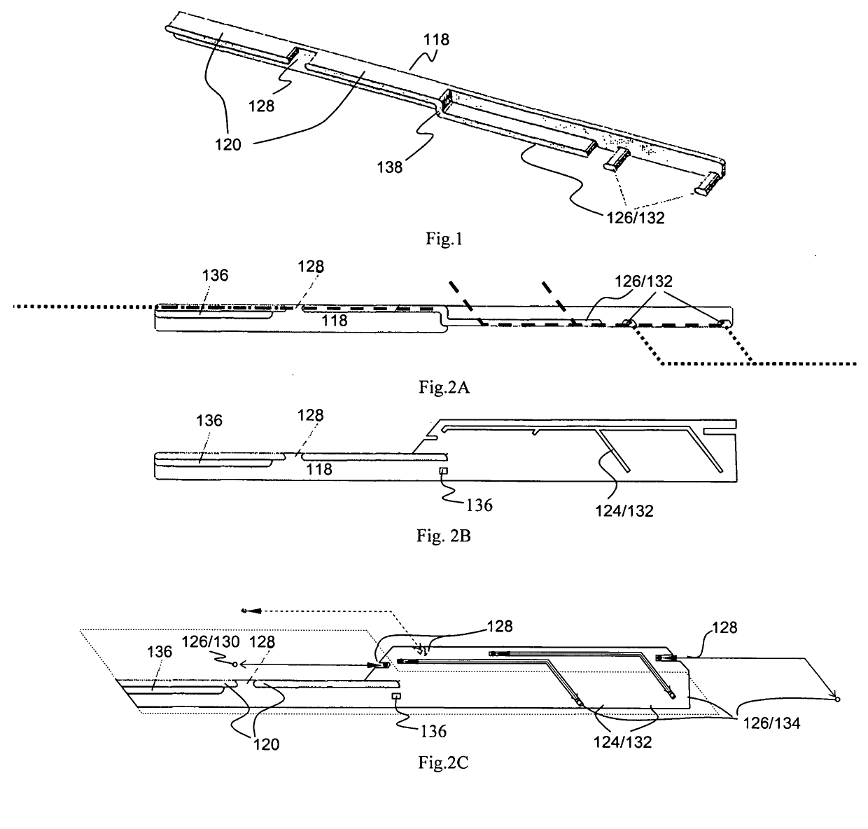

FIG. 2A shows a plan view of the link element of FIG. 1.

This link element gives a novel, very simple but excellently functional mechanical solution to mechanical movement that solves most of the problems present in the concept and earlier inventions to the mechanism. It enables required motion and a complex change of the level of the display housing element/fist housing element. The mechanism requires only little space in width direction and allows thin and compact implementation. Mechanism works smoothly, intuitively and has good stiffness.

One embodiment of the slide mechanism is based on the L-shaped rails (depicted schematically as interrupted lines in the retracted position and indicated as dotted lines in the extended position) that take place on the both sides of the phone. The interrupted lines indicate the position of the sliding path in the retracted position. The dotted lines indicate the position of the sliding path in the extended position. Rails connect the housing elements together allowing long linear extending motion, but also display/first housing element (not depicted) to fall to the same level as the keyboard/second housing element (not depicted).

FIG. 2B shows a plan view of another embodiment or a link element. In FIG. 2B the fist sliding elements are embodied as a Y-shaped groove in which two pins of the first housing element may be sliding and shifting along a substantially L-shaped path. On the left side the groove is slightly bent downwards. The slightly bent downwards section of the groove lifts the first housing element from the second housing element during the extending movement. By lifting the first housing element small, elevated structural elements such as keypads or the like may be compensated. An additional advantage of such a low-high-low design (low end positions high/elevated motion) reside in the avoidance of situations in which an object may get stuck between the first and the second housing element and may block the sliding mechanism connecting the housing elements.

FIG. 2C shows a plan view of another embodiment or a link element. In FIG. 2C, the fist sliding elements are embodied as two substantially L-shaped grooves in which two pins may be located to slide along a substantially L-shaped path, so that a housing element sliding along said path performs a parallel translation along the path indicated by the buckled double arrows. In FIG. 2C, the position of the pins sliding in said grooves is depicted in the retracted position by the black dots. The closing movement of the two housing elements is indicated by the triangular ends of the arrows. In FIG. 2C the position of the pins sliding in said grooves is indicated in the extended position by the circles. The extending movement of the two housing elements is indicated by the “>”-ends of the arrows. The pins (associated with the two arrows in the middle) provide the l-shaped sliding path of the first housing element. It may be noted that the sliding grooves may also be embodied with a smooth transition between the two sides or legs of the l-shaped grooves.

In FIG. 2C, two horizontal notches are indicated associated with the two arrows on each side of the link element. The notch on the right side is provided to receive a pin located on the fist housing element when the housing elements are brought into the retracted position. The notch on the left side is provided to receive a pin located on the second housing element when the housing elements are brought in the retracted position. It is also envisaged to embody a notch on the top side (indicated by interrupted lines) provided to receive a pin (indicated by interrupted lines) located on the fist housing element when the housing elements are brought in the extended position. The top side notch may serve to stabilize the housing in the extended position. The two horizontal notches serve to stabilize the housing in the retracted position. It is also envisaged to provide catches and/or pawls on (at least one of) the housing elements or the link element to lock the housing elements in the extended or retracted position.

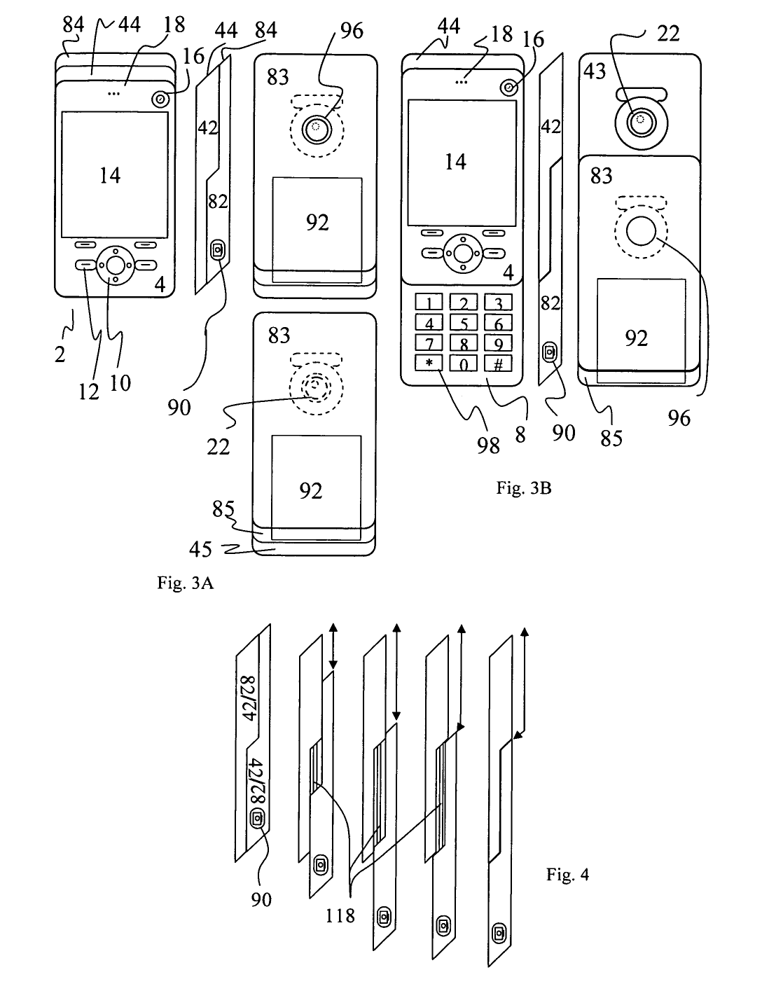

FIGS. 3A and 3B show an example embodiment of an extensible mobile electronic device of the present invention in different plan views. The depicted extensible mobile electronic device is embodied as an extensible cellular phone. The single views are from left to right in FIG. 3A: front plan view side plan view and rear plan view, each in the retracted position. The single views are from left to right in FIG. 3B: front plan view side plan view and rear plan view, each in the extended position.

In FIG. 3A the mobile terminal device 2 is embodied as a cellular phone with a big display 14 a few basic control keys (with a 4-way-navigation button 10 and menu keys 12) and a small video phone camera 16 top at the right side and an earpiece 18 centered over the display 14. In the front view, mainly the first housing part is visible. At the top a part of the inclined top face of the phone with a parting line between the first housing part 4 and the second housing part 8 is visible. The inclined top side of the second housing part 84 is visible on the top edge of the front view.

The parallelogram shaped structure in the middle of FIG. 3A is the right hand side view of the mobile phone provided with a housing unlocking button (or a shutter release button) 90. The parting line between the first housing part in the side view 42 and the second housing in the side view 82 part is visible and divides this embodiment into substantially similar shaped housing parts. The first and the second housing elements are fully overlapping in a conforming way. Is it also envisaged to implement an unlocking key e.g. at the (not depicted) left side of the device.

The drawing on the right side of FIG. 3A shows a rear view of the terminal device in two different implementations. The upper rear view of the terminal device shows an aperture 96 for a lens of a camera module 22 in the first housing that can be seen through said aperture 96 in the second housing element in rear view 83.

The lower rear view of the terminal device shows no aperture for a lens. The camera module 22 in the first housing module is only indicated in interrupted lines. In the rear view also cover for a battery compartment 92 (and SIM and/or memory cards) is indicated by the small rectangle in the lower section of the rear view under the lens 22.

The left drawing of FIG. 3B is a front view of the device in the extended position, wherein at the upper part the inclined top part of the second housing component is not longer visible and at the lower housing section the second housing element 8 with an ITU-T keyboard 98 is visible.

The drawing in the middle of FIG. 3B shows the parallelogram shaped structure of the right hand side view of the mobile phone of FIG. 1A in the extended position. The unlocking button 90 indicates the second housing element in the side view 82. The first and the second housing elements are partially overlapping in a conforming way. In the extended position the mobile phone has a shallower but more extended configuration.

The right drawing of FIG. 3B shows the rear view of the mobile phone in the extended position. In the extended position the lens of the camera module 22 is fully visible and operable (in both embodiments with or without said aperture 96 in the second housing element in rear view 83).

The electronic device depicted in FIGS. 3A and 3B has a “two step”-configuration as both the first and the second housing element correspond to a two-step stepladder or a two-step library step that can be placed on top of each other with the steps facing.

FIG. 4 shows a side view of an embodiment of the present invention to illustrate a possible extending motion by a combination of two successive linear motions. This motion may be implemented by curved rails or by retractable rails (118).

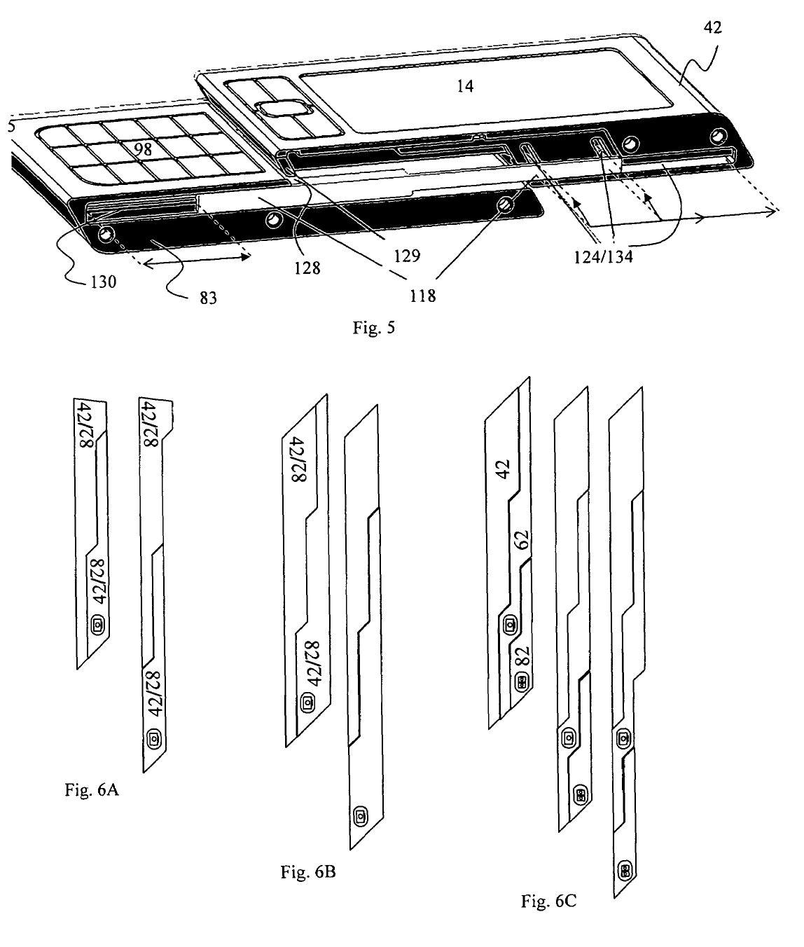

FIG. 5 shows a perspective of an embodiment of the present invention to illustrate a possible extending motion by a combination of two successive linear motions. To visualize the mechanic the link element depicted in an enlarged view in FIGS. 1 and 2A is engaged in the respective guideway 130 and into the pair of second sliding elements 134, embodied as a Y-shaped groove in the first housing element. The arrows indicating the movement refer to the movement of the link element in relation to each of said housing element (wherein the arrows do not comprise the superimposition of the movements of both housing elements).

For the proper functionality of the concept, it is envisaged to shape the rail to be robust. An idea of increasing the robustness of the system reside in the usage of L-shaped (see FIGS. 1, 2A) linking element (rails). An L-shape removes effectively unwanted lateral rotation and increases stiffness with only little extra space needed. To minimize the space required needed by the rail the L-shape changes its side in the middle (FIGS. 1, 2A, reference number 138), so that rail is as near the cover as possible inside both housing elements. The length of the linking element(s) should be as long as the housing elements allowing maximizing the support face. Rail has also a little bracket at the other side for the same reason.

When user wants to extend the electronic device he/she starts to slide the first housing element relatively to the second housing element. That makes rails move so that, in fact, both housing elements move half of the overall distance relatively to rails. When the first housing element has slide enough, pins 126 inside the first housing element and a stopper 136 inside the second housing element stop the linear motion and prevent the housing elements from dropping out from the rail (i.e. the guide way and said pair of second sliding elements).

However, there is still a lot of motion energy left and so that the first housing element starts finally shift to the same level as the second housing element due to the pins of rails and grooves 124/134 in the first housing element. In this phase rails don't move anymore, but housing element moves relatively to rails. Two pins (not visible) prevent rotation between housing elements.

The mechanical concept has sliding elements on each side to connect the housing elements onto each other, sliding first and then dropping down in the end. There are also small guiding pins in bottom corners of the upper (e.g. first) housing element that are connected to the small grooves in the lower (e.g. second) housing element. These could also be moved to “lower level” of the housing elements to produce the same effect.

For the stiffness of the linking element is critical so it is necessary to have very small margins and so the shape of pins and grooves in the first housing element significantly contribute to make the concept stable. In addition, the housing element has also other protrusions 129 that engage the holes/notches in the rails (FIGS. 1, 2A, reference number 128) and increase robustness. These pins also makes holes needed for rails as small as possible at the bottom of the first housing element.

This embodiment presents a very simple and functional mechanical solution to form factor called slide or “level slide”, where the first and second housing elements move similarly in relation to each other, sliding half of the device's length and then dropping/shifting down half of the device's length in an extending direction, and vice versa in closing direction. The mechanical concept has sliding bars on each side to connect the housing elements to each other, sliding first and then dropping down in the end. There are also small guiding pins in bottom corners of the upper housing element, which are connected to the small grooves in the lower housing element. These could also be moved to “lower level” of the housing elements to produce the same effect. Also other similar variations are possible. The benefits are that the new mechanism is slightly smaller, considerably simpler, low cost, sturdy, with much smaller clearances, and hence has a lot better quality for user.

FIGS. 6A to 6C show three different implementations of sliding of movable configurations each in a retracted and in an extended position in a side view. In the implementation of FIG. 6A the first housing element (on the left side) has an extended upper section. The second housing element (on the right side) has the configuration of the respective elements as in the FIGS. 1 and 3 to 6 and is provided with an unlocking button. In this configuration only the retracted configuration has a substantially flat-sided configuration, while in the extended position the rear surface has a protrusion in the upper part of the device. This configuration allows different extension ratios between e.g. a factor from approximately 1.1 up to 1.5.

The configuration of FIG. 6B provides a three-step configuration with substantially similar form. This configuration allows it to achieve an extension ratio of approximately 1.3 with a configuration that allows a parellelepipedal configuration in the extended and in the retracted position. Another advantage of this configuration is the larger overlapping area allowing a more solid configuration of the extendable connection. This embodiment represents a “three-step” stepladder implementation of the housing.

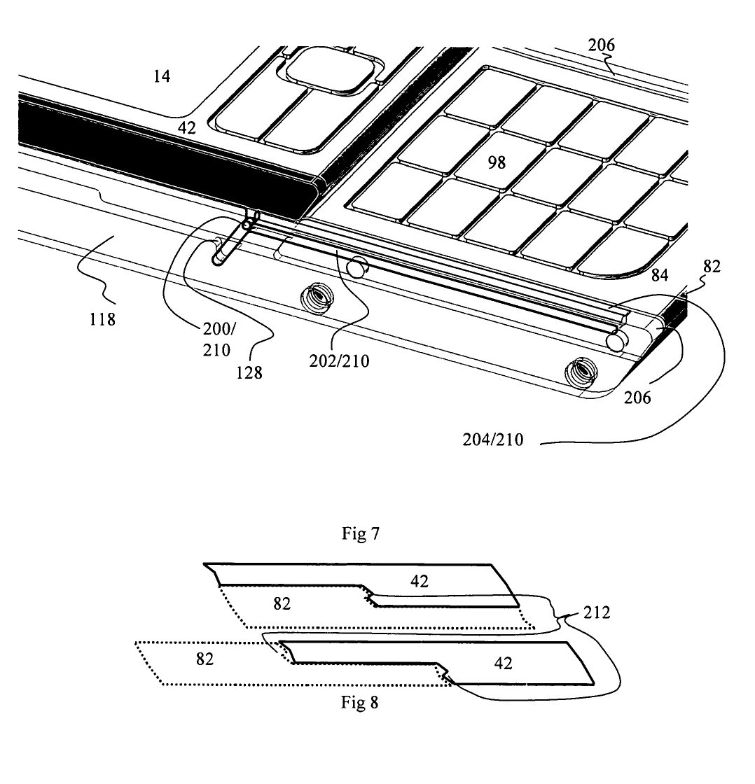

FIG. 7 shows schematic perspective side views of an extendable device to visualize the relative motion of the two housing elements, each provided with housing engagement elements 210. The first housing element 42 is provided with a rail pin 200 running in and along the guide rail 202. The guide raid has a substantially L-shaped cross section and opens to the top face of the second housing element in groove 204. The rail pin 200 is connected to the first housing element 42 by a projection. In combination, the rail pin 200 and the projection have a substantially L-shaped configuration. It is also envisaged to provide the rail pin with elements to improve the functionality of sliding mechanisms, such as reducing the friction between the slide pin 200 and the guide rail 202. It is also envisaged to provide the guide rail 202 at the groove 204 with a flexible lip to prevent that dust may enter the guide rail and may increase the friction or block the slide mechanism. To improve the functionality of the slide mechanism, the pin may be provided with a small roller running in said guide rail. It is also envisaged to use a kind of a two-axis inline buggy angled as said pin and running in said guide rail to enhance the smoothness of the movement pin in the guide rail. It is also contemplated to provide the guide rail with a liner to reduce friction.

The slide pin 200 (or better the projection) may engage the notch 128 to additionally immobilizing the linking element 118 with respect to the first housing element.

FIG. 8 shows a side view of an embodiment of a mobile electronic terminal device provided with housing engagement portions 212 in retracted and extended configuration, respectively. In FIG. 8, the housing engagement elements are embodied as protrusions in the “step” of the respective housing element. The protrusions are provided with engagement portions 212 provided for mutual engagement of the respective housing only in the retracted position. To accommodate the protrusions in the extended position it is necessary to provide the small ends of the housings with respective recesses as depicted in the extended position of the housing of FIG. 8.

The configuration of FIG. 6C is provided with three housing elements 42, 62, 82 with a three-step and a two-step configuration. This configuration allows it to achieve extension ratios above 1.5 up to 2. This configuration allows at least in the fully retracted position a parellelepipedal shape. Another advantage of this embodiment is the larger overlapping area allowing a more solid configuration of the extendable connection. Only in the fully extended configuration and if the second element is extended a flat front surface is achieved. If only the third housing element 62 is extended (not depicted) the front surface of the third housing element 62 is not adjacent and not flushing with the front surface of the first housing element 42.

This application contains the description of implementations and embodiments of the present invention with the help of examples. It is explicitly noted that an artisan may also combine features encompassed in the different embodiments depicted in the figures. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the claims accompanying. Consequently various options of implementing the invention as determined by the claims, including equivalent implementations, also belong to the scope of the invention.

### LIST OF REFERENCE NUMERALS

2 extensible mobile electronic device
4 first housing element/front face of first housing element
8 second housing element/front face of second housing element
10 four/five-way rocker key/browsing key/big thumb stick
12 menu key
14 display/touch screen display
16 front camera module
18 earpiece
22 camera module/lens
42 side face of first housing element
43 rear face of first housing element
44 top face of first housing element
45 bottom face of first housing element
62 side face of third housing element
82 side face of second housing element
83 rear face of second housing element
84 top face of second housing element
85 bottom face of second housing element
90 release button/shoulder key
92 battery case
96 aperture for camera module 22
98 ITU-T keyboard
118 link element
120 guiding rail
124 groove (curved)
126 groove stone/pin
128 notch
129 protrusion
130 guideway
132 pair of first sliding elements
134 pair of second sliding elements
136 stopper
138 side change of L-shape
200 rail pin
202 guide rail
204 groove (entrance of the slide rail)
206 side plate
210 housing engagement element
212 engagement portion

What is claimed is:

1. An extendible mobile electronic device, comprising
a device housing having
at least a first housing element, which comprises a first front surface and a first rear surface, and
a second housing element, which comprises a second front surface and a second rear surface,
and
one or more slide mechanisms, each of which comprising
a linking element having a sliding rail and a pair of first sliding elements,
a guideway element located at the second housing element, being in slidable engagement with said sliding rail and
a pair of second sliding elements located at the first housing element, which are in slidable engagement with said first sliding elements,
wherein said first housing element and said second housing element are extensibly supported by said slide mechanisms to each other, such that said first and second housing elements can adopt a retracted configuration and an extended configuration with respect to each other.

2. The device according to claim 1, wherein a conversion of said device housing from said retracted configuration to said extended configuration permits a first movement of said housing elements substantially in parallel to each other and a second movement of said housing elements approaching each other.

3. The device according to claim 1, wherein said first sliding elements and said second sliding elements allow a first movement of said housing elements substantially in parallel to each other and a second movement of said housing elements approaching each other.

4. The device according to claim 1, wherein at least one of said first sliding elements is formed by at least one guiding groove and at least one of said second sliding elements is formed by a pin.

5. The device according to claim 4, wherein each said at least one guiding groove is curved.

6. The device according to claim 1, wherein at least one of said second sliding elements is formed by at least one guiding grooves and at least one of said first sliding elements is formed by a pin.

7. The device according to claim 6, wherein each said at least one guiding groove is curved.

8. The device according to claim 1, wherein said sliding rail and said guideway element elements are enabled for sliding guided by said guideway elements allowing said housing elements to move against each other in a direction of extension.

9. The device according to claim 1, wherein said pair of first sliding elements and, said pair of second sliding elements located at the first housing element, being in slidable engagement with said first sliding elements are enabled for sliding said first housing element in relation to said second housing element to approach each other by a shifting movement, while substantially maintaining orientations of said housing elements in relation to each other.

10. The device according to claim 9, wherein a direction of extension and a direction of said shifting movement are arranged at an angle between 20° and 70°, between 25° and 65°, between 30° and 60°, between 35° and 55°, between 40° and 50° or between 60° and 70°.

11. The device according to claim 1, wherein an orientation of said guideway elements and said sliding rails defines a direction of extension of said extendible device housing.

12. The device according to claim 1, wherein one of said slide mechanisms is arranged at a side of said device housing and another one of said slide mechanisms is arranged at an opposite side of said device housing, wherein said side and opposite side of said device housing are defined in relation to a direction of extension, wherein said slide mechanisms are internally arranged with said device housing.

13. The device according to claim 1, wherein one of said slide mechanisms is arranged at a side of said device housing and another one of said slide mechanisms is arranged at an opposite side of said device housing, wherein said side and opposite side of said device housing are defined in relation to a direction of extension, wherein said slide mechanisms are externally arranged with said device housing.

14. The device according to claim 1, wherein in said retracted configuration, said first housing element and said second housing element are located substantially on top of each other, said first rear surface conformingly adjoining said second front surface.

15. The device according to claim 1, wherein in said extended configuration, said first housing element is displaced with respect to said second housing element, wherein said first rear surface is partially adjoining said second front surface.

16. The device according to claim 1, wherein in said extended configuration, said first front surface flushes with said second front surface, wherein said first housing element and second housing element are arranged at a same level, substantially.

17. The device according to claim 1, wherein said device comprises a combined linking element having two sliding rails and two pairs of first sliding elements; two guideway elements are located at opposite sides of said second housing element, each being in slidable engagement with one of said two sliding rails and; two pairs of second sliding elements located at opposite sides of the first housing element, being in slidable engagement with said first sliding elements.

18. The device according to claim 1, wherein said first rear and said second front surfaces have a stepped configuration.

19. The device according to claim 1, further comprising:
a display arranged on said first front surface,
a user input interface element arranged on said section of said second front surface, and
processing means connected to said display and to user input interface element.

20. The device according to claim 19, further comprising:
one or more applications operable with said device; and
a sensor for detecting said configuration of said device housing;
wherein said applications are reactive to a signal supplied by said sensor, which signal indicate said housing configuration.

21. The device according to claim 1, further being provided with a pawl for locking said housing in said retracted and/or in said extended configuration.

22. The device according to claim 1, further comprising a cellular telephone module for enabling cellular communications.

23. The device according to claim 1, further comprising a spring for biasing the first and second housing elements with respect to each other.

24. The device according to claim 1, further comprising
a first housing engagement element and
a second housing engagement element,
wherein said first housing engagement element is located at said first housing element,
wherein said second housing engagement element is located at said second housing engagement element, and
wherein said first and second housing elements are configured to engage each other in at least one position of the device.

25. The device according to claim 24, wherein said first housing engagement element and said second housing engagement element comprise a rail pin and a guide rail, respectively.

26. The device according to claim 24, wherein said first housing engagement element and said second housing engagement elements, comprise engagement portions to engage each other in the retracted or in the extended position.

27. A slide mechanism, comprising
a linking element having a sliding rail and a pair of first sliding elements,
a first frame element being provided for being attached to one of said first and second housing elements comprising a guideway element, being in slidable engagement with said sliding rail and
second frame element being provided for being attached to the other one of said first and second housing elements comprising a pair of second sliding elements, being in slidable engagement with said first sliding elements.

28. The slide mechanism according to claim 27, wherein said first sliding elements and said second sliding elements allow a first movement of said frame elements substantially in parallel to each other and a second shift movement of said housing elements approaching each other.
